(19) United States
(12) Patent Application Publication
(10) Pub. No.: US 2007/0069053 A1
(43) Pub. Date: Mar. 29, 2007

(54) Crusher for rubble and similar

(76) Inventor: Luca Ortoncelli, Villorba (IT)

Correspondence Address: Berenato, White & Stavish, 6550 Rock Spring Drive, Suite 240, Bethesda, MD, 20817, US

(21) Appl. No.: 10/555,008

(22) PCT Filed: Mar. 30, 2005
(86) PCT No.: PCT/EP05/51446

§ 371 Date: Jul. 12, 2006

(30) Foreign Application Priority Data
Mar. 3, 2004 (IT) TO2004A 000211

(51) Int. Cl. B02C 13/09

(52) U.S. Cl. 241/189.1

(57) ABSTRACT

A crusher for rubble and similar, having an outer casing, a rotary drum mounted for rotation inside a crushing chamber formed in the outer casing, and at least one baffle plate positioned inside the crushing chamber to direct the raw material entering the crushing chamber onto the peripheral surface of the rotary drum; the baffle plate being hinged to the outer casing to oscillate, inside the crushing chamber, about a given rotation axis; and the crusher also having connecting members for connection to the casing which have at least one floating-piston, linear hydraulic actuator interposed between the body of the baffle plate and the outer casing of the crusher to adjust the tilt angle of the at least one baffle plate as required with respect to the vertical.

### TECHNICAL FIELD

The present invention relates to a crusher for rubble and similar.

More specifically, the present invention relates to a rotary-drum crusher for crushing rubble, rock and quarry material in general, building and road demolition waste, and metal industrial waste such as scrap and similar.

### BACKGROUND ART

As is known, rotary-drum crushers comprise an outer machine body or casing, and a jagged-surfaced rotary drum mounted for rotation inside a crushing compartment or chamber formed inside the machine body. The top of the crushing chamber communicates with the outside via a chute down which the raw material is fed to the rotary drum, and the bottom of the crushing chamber communicates with the outside via a hopper through which the crushed material drops by gravity out of the chamber.

Known rotary-drum crushers also comprise one or two baffle plates located inside the crushing chamber, just above the rotary drum, to direct onto the rotary drum both the incoming raw material off the top feed chute, and the splinters of material hurled in all directions by rotation of the drum. The baffle plates are positioned inside the crushing chamber so that the bottom lateral edge of each plate defines, with the peripheral surface of the rotary drum, a gap or narrow passage whose width determines the maximum size of the crushed material from the crushing chamber.

To adjust the maximum size of the crushed material from the crushing chamber, the baffle plate or plates of most known rotary-drum crushers are hinged to and project from the walls of the outer machine body or casing so as to oscillate freely about horizontal axes parallel to the rotation axis of the drum, and are maintained in a tilted position inside the crushing chamber by means of connecting members for connection to the casing and which extend from the plates to the machine casing to adjust the tilt angle as required with respect to the vertical, and therefore the distance between the bottom lateral edge of the plate and the peripheral surface of the rotary drum.

In addition to locking the baffle plates in the desired crushing position, the connecting members for connection to the casing must obviously also provide for cushioning and absorbing the mechanical stress produced both by routine crushing and by penetration of any large non-compressible bodies.

This dual function is routinely performed by all-mechanical or combined mechanical-hydraulic systems.

More specifically, all-mechanical connecting members currently comprise an anchoring stay for holding the plate in the desired position; and one or more helical cushioning springs fitted to the stay so that one end rests on the body of the plate, and the other end rests on the machine casing. The stay is normally defined by a threaded bar, the head of which is attached to the plate, and the rod of which is fitted through a slot formed in the machine casing; and a lock nut is screwed to the end of the rod to adjust the tilt of the plate with respect to the vertical. The helical cushioning springs are precompressed to act as rigid members as long as mechanical stress remains below a given threshold value, and to deform elastically to permit backup/lift of the plate in the event of a sudden increase in mechanical stress over and above a given threshold value.

Which value is obviously below the mechanical stress produced by the presence of a large non-compressible body jammed inside the gap between the plate and the rotary drum.

Alternatively, combined mechanical-hydraulic connecting members are also used, in which the cushioning springs are replaced by a hydraulic shock-absorber, while the anchoring stay again provides for holding the plate in the desired position when the crusher is running.

Unfortunately, a major drawback of both crushers featuring all-mechanical connecting members and crushers featuring combined mechanical-hydraulic connecting members lies in tilt adjustment of the baffle plates being a complicated, time-consuming job, with all the disadvantages this involves.

### DISCLOSURE OF INVENTION

It is therefore an object of the present invention to provide a rotary-drum crusher for rubble and similar, designed to eliminate the aforementioned drawbacks.

According to the present invention, there is provided a crusher for rubble and similar, comprising an outer casing, a rotary drum mounted for rotation inside a crushing chamber formed in the outer casing, and at least one baffle plate positioned inside the crushing chamber to direct the raw material entering the crushing chamber onto the peripheral surface of said rotary drum; said at least one baffle plate being hinged to said outer casing to oscillate, inside the crushing chamber, about a given rotation axis; and the crusher also having connecting members for connection to the casing which extend from the outer casing to the baffle plate to adjust the tilt angle of said at least one baffle plate as required with respect to the vertical; said crusher being characterized in that said connecting members comprise at least one floating-piston, linear hydraulic actuator interposed between the body of the baffle plate and the outer casing of the crusher.

### BRIEF DESCRIPTION OF THE DRAWINGS

A non-limiting embodiment of the present invention will be described by way of example with reference to the accompanying drawings, in which:

FIG. 1 shows a schematic section, with parts removed for clarity, of a crusher for rubble and similar, in accordance with the teachings of the present invention;

FIG. 2 shows a schematic section, with parts removed for clarity, of a component part of the FIG. 1 crusher;

FIGS. 3 to 5 show the FIG. 2 component part in respective operating configurations.

### BEST MODE FOR CARRYING OUT THE INVENTION

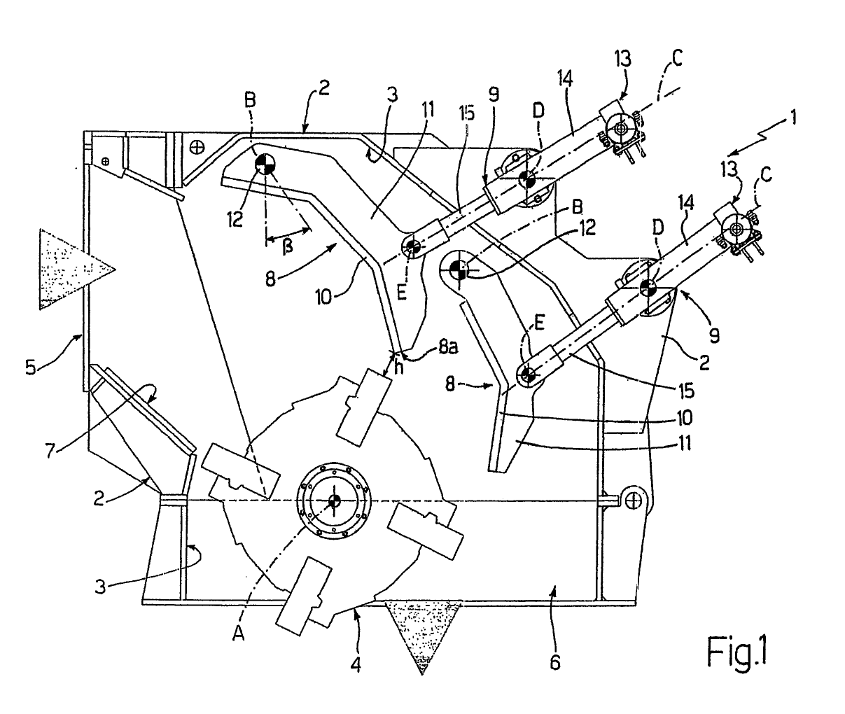

Number 1 in FIG. 1 indicates as a whole a rotary-drum crusher, which is particularly advantageous for use in crushing rubble, rock and quarry materials in general, building and road demolition waste, and metal industrial waste such as scrap and similar.

Crusher 1 substantially comprises an outer machine body or casing 2, in which an appropriately shaped crushing compartment or chamber 3 is formed; a jagged-surfaced rotary drum 4 fitted inside crushing chamber 3 to rotate about a respective preferably, though not necessarily, horizontal longitudinal axis A; and a drive unit (not shown) connected mechanically to rotary drum 4 to rotate it at preferably, though not necessarily, constant speed about longitudinal axis A.

The top of crushing chamber 3 communicates directly with the outside via a raw-material inlet 5 formed at the top of outer machine body or casing 2; and the bottom of crushing chamber 3 communicates directly with the outside via a crushed-material outlet 6 formed at the bottom of outer machine body or casing 2. Rotary drum 4 is located inside crushing chamber 3, between inlet 5 and outlet 6, and is designed to crush, as it rotates, the material fed by gravity into crushing chamber 3 through inlet 5.

In the example shown, at inlet 5, outer machine body or casing 2 comprises a feed chute 7 along which raw material is fed to rotary drum 4 along a trajectory inclined at a given angle with respect to the vertical; and the bottom of outer machine body or casing 2, at outlet 6, is designed for connection to a known hopper (not shown) through which the crushed material drops by gravity out of crushing chamber 3.

With reference to FIG. 1, crusher 1 also comprises at least one baffle plate 8 located inside crushing chamber 3, just above rotary drum 4, and shaped to direct onto the peripheral surface of rotary drum 4 underneath both the incoming raw material off chute 7, and the splinters of material hurled in all directions by rotation of rotary drum 4.

More specifically, baffle plate 8 is tilted with respect to the vertical inside crushing chamber 3 so that the bottom lateral edge 8a of baffle plate 8 defines, with the peripheral surface of rotary drum 4, a gap or narrow passage whose width h determines the maximum size of the crushed material from crushing chamber 3.

More specifically, baffle plate 8 is hung from, or rather hinged to and projects from, outer casing 2 so as to oscillate freely inside crushing chamber 3 about a rotation axis B parallel to longitudinal axis A of rotary drum 4, and is held in a given tilted position by connecting members 9 for connection to the casing and which extend from outer casing 2 to the body of baffle plate 8 to adjust the tilt angle β of the plate as required with respect to the vertical, and so adjust as required the minimum distance between bottom lateral edge 8a of baffle plate 8 and the peripheral surface of rotary drum 4, i.e. width h of said gap or narrow passage.

With reference to FIG. 1, the example shown comprises two baffle plates 8 arranged inside crushing chamber 3 so that the first baffle plate 8 is located just above rotary drum 4 and facing chute 7, and the second baffle plate 8 is located lower down, immediately downstream from the first baffle plate 8, in the space between rotary drum 4 and the lateral wall of outer casing 2, and aligned with the gap or narrow passage defined by bottom lateral edge 8a of the first baffle plate 8 and the peripheral surface of rotary drum 4.

In addition to the above, each of the two baffle plates 8 in the example shown comprises a flat front plate 10 bent substantially into a C or L shape and extending parallel to longitudinal axis A of rotary drum 4, with its concavity facing rotary drum 4; and a rear supporting frame 11 having, at the top, a cylindrical pin 12 coaxial with rotation axis B and inserted at both axial ends, so as to rotate freely, inside the lateral walls of outer casing 2.

With reference to FIGS. 1, 2 and 3, each connecting member 9 for connection to the casing comprises at least one floating-piston, linear hydraulic actuator 13 interposed between outer casing 2 of the crusher and rear supporting frame 11 of baffle plate 8. More specifically, each connecting member 9 for connection to the casing may comprise one or a number of parallel, side by side, floating-piston, linear hydraulic actuators 13, each interposed between outer casing 2 of the crusher and rear supporting frame 11 of baffle plate 8.

Each linear hydraulic actuator 13 extends coaxially with a longitudinal axis C lying preferably, though not necessarily, in a plane perpendicular to axes A and B, and comprises a hollow cylindrical body 14 coaxial with longitudinal axis C; and a movable rod 15 coaxial with longitudinal axis C and at least partly inserted telescopically and in axially sliding manner inside hollow cylindrical body 14. Hollow cylindrical body 14 is hinged to outer casing 2 to oscillate freely about a rotation axis D perpendicular to longitudinal axis C of hollow cylindrical body 14 and parallel to rotation axis B of baffle plate 8, and the free end of movable rod 15 is hinged to rear supporting frame 11 of baffle plate 8 to oscillate freely about a rotation axis E parallel to rotation axis D.

Linear hydraulic actuator 13 also comprises a main piston 16 and a floating auxiliary piston 17, both mounted to slide axially inside the longitudinal cavity 14a of hollow cylindrical body 14. Main piston 16 is fixed rigidly to the end of movable rod 15 inside hollow cylindrical body 14, while floating auxiliary piston 17 is fitted to slide axially on an intermediate portion of movable rod 15.

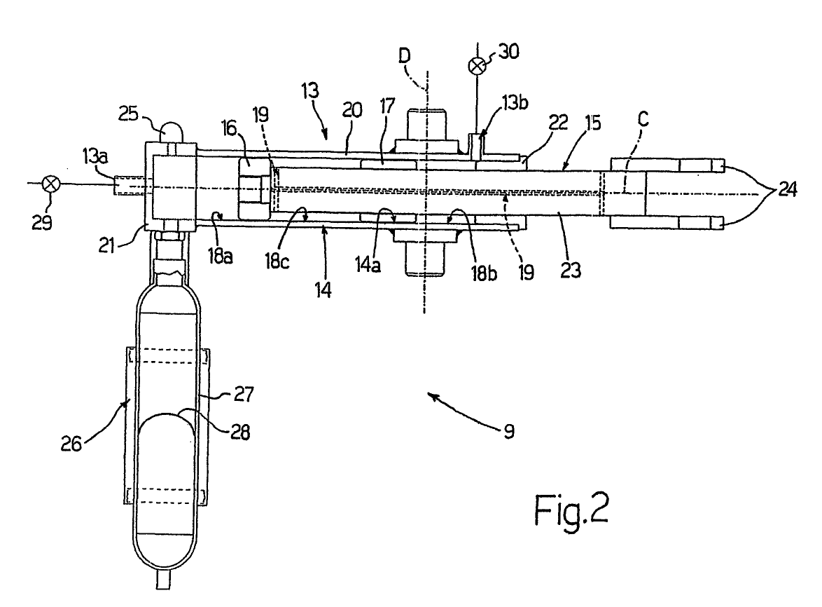

With reference to FIG. 2, main piston 16 and floating auxiliary piston 17 both have a cross section complementary to that of longitudinal cavity 14a of hollow cylindrical body 14, so as to slide freely, parallel to longitudinal axis C, inside longitudinal cavity 14a, and divide the space inside longitudinal cavity 14a into three complementary variable-volume chambers 18a, 18b, 18c aligned along longitudinal axis C.

More specifically, variable-volume chamber 18a is bounded laterally by main piston 16 and a first end wall of longitudinal cavity 14a; variable-volume chamber 18b is bounded laterally by floating auxiliary piston 17 and a second end wall of longitudinal cavity 14a; and variable-volume chamber 18c is bounded laterally by main piston 16 and floating auxiliary piston 17.

Variable-volume chambers 18a and 18b at the two ends of longitudinal cavity 14a, i.e. the lateral chambers, are filled with pressurized oil, and variable-volume chamber 18c, i.e. the central chamber, communicates directly with a pressurized-gas or -fluid source via a connecting conduit 19 formed, in the example shown, in movable rod 15, so that the volume of variable-volume chamber 18c depends on the total volume of variable-volume chambers 18a and 18b.

Hollow cylindrical body 14 therefore has two pressurized-oil inlets 13a and 13b, by which to feed or draw pressurized oil to or from variable-volume chambers 18a and 18b at the two ends of longitudinal cavity 14a, while the pressurized-gas or -fluid source may advantageously be defined by the outside atmosphere or, obviously, by a specific branch of the hydraulic circuit of the crusher.

With reference to FIG. 2, when movable rod 15 withdraws inside hollow cylindrical body 14, the volume of variable-volume chamber 18a is reduced and the total volume of variable-volume chambers 18b and 18c is increased.

With reference to FIG. 2, hollow cylindrical body 14 is preferably, though not necessarily, defined by a cylindrical tubular sleeve 20 of appropriate length extending coaxially with longitudinal axis C, and by and endpiece 21 and a cap 22 closing both ends of the sleeve. Cap 22 has a central through hole sized to receive and permit slide of movable rod 15 with no pressurized-oil leakage.

Variable-volume chamber 18a is therefore bounded laterally by the body of main piston 16 and endpiece 21, and variable-volume chamber 18b is bounded laterally by the body of floating auxiliary piston 17 and cap 22.

Movable rod 15 is defined by a cylindrical bar 23 of appropriate length, and by a fork 24 fixed rigidly to the end of the bar outside hollow cylindrical body 14. Fork 24 is hinged to rear supporting frame 11 of baffle plate 8 by a known cylindrical pin coaxial with axis E.

With reference to FIG. 2, in addition to the above, connecting members 9 for connection to the casing to of crusher 1 comprise, for each linear hydraulic actuator 13, a respective relief valve 25 communicating directly with variable-volume chamber 18a of hollow cylindrical body 14, and which permits selective pressurized-oil outflow when the oil pressure in variable-volume chamber 18a exceeds a first given threshold value.

Connecting members 9 for connection to the casing preferably, though not necessarily, also comprise, for each linear hydraulic actuator 13, a pressurized-oil storage tank 26 communicating directly, and exchanging pressurized oil when necessary, with variable-volume chamber 18a of hollow cylindrical body 14, and which receives a variable quantity of pressurized oil from variable-volume chamber 18a when the oil pressure in variable-volume chamber 18a exceeds a second given threshold value lower than the first threshold value of relief valve 25.

In the example shown, storage tank 26 is a conventional bag-type pressurized-oil storage tank substantially comprising a fluidtight container 27 with an elastically deformable partition membrane 28 inside which divides the internal volume into two complementary variable-volume chambers. The first chamber communicates directly with variable-volume chamber 18a of hollow cylindrical body 14 and contains pressurized oil, while the second chamber is isolated from the outside and contains a gas at an adjustable predetermined reference pressure value lower than the first threshold value to activating relief valve 25.

With reference to FIG. 2, connecting members 9 for connection to the casing each also have two on-off valves 29, 30, each for regulating pressurized-oil flow to and from a respective variable-volume chamber 18a, 18b of hollow cylindrical body 14 through the corresponding pressurized-oil inlet 13a, 13b.

Operation of crusher 1 as a whole is easily deducible from the foregoing description with no further explanation required.

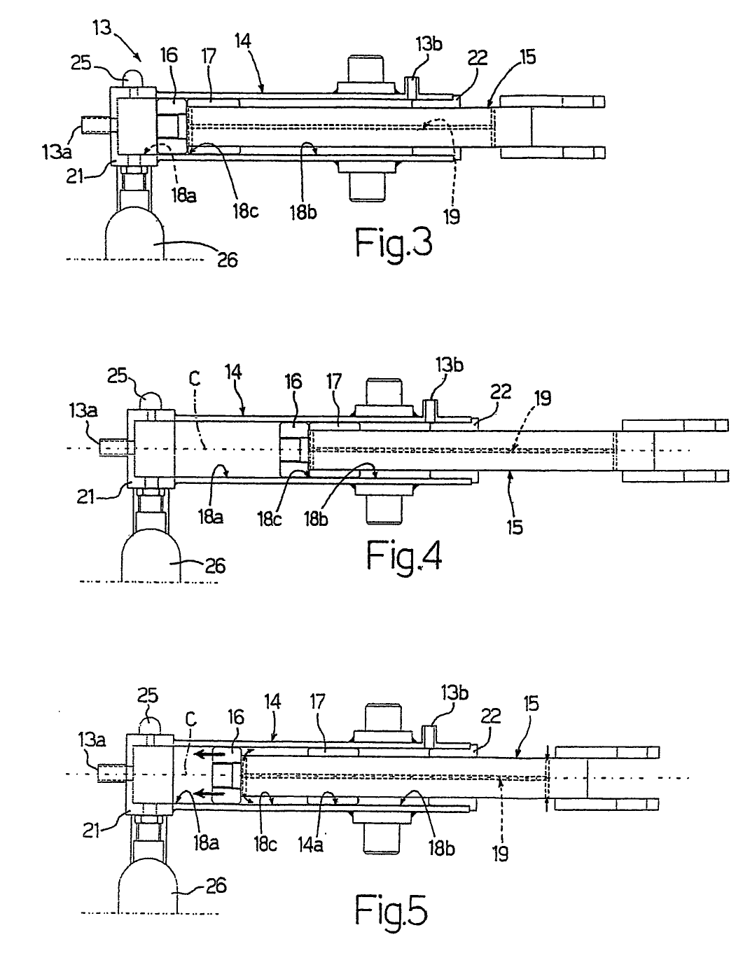

Operation of connecting members 9 for connection to the casing, however, will be described with reference to the tilt adjustment of one baffle plate 8, and commencing from a parking position of baffle plate 8, in which linear hydraulic actuator 13 is in a rest configuration (FIG. 3) in which movable rod 15 is fully withdrawn inside hollow cylindrical body 14, and floating auxiliary piston 17 rests against main piston 16. In this configuration, the total volume of variable-volume chamber 18a is minimum, the total volume of variable-volume chamber 18b is maximum, and the total volume of variable-volume chamber 18c is minimum.

In actual use, commencing with linear hydraulic actuator 13 in the rest configuration (FIG. 3), on-off valves 29 and 30 are opened, and the hydraulic circuit of the crusher feeds pressurized oil into variable-volume chamber 18a through inlet 13a. The incoming pressurized oil obviously increases the volume of variable-volume chamber 18a and accordingly reduces the total volume of variable-volume chamber 18b, so that pressurized oil is expelled through inlet 13b back to the hydraulic circuit of the crusher.

With reference to FIG. 4, when movable rod 15 moves out by the desired length from hollow cylindrical body 14, thus setting baffle plate 8 to the desired work position, i.e. to the predetermined tilt angle β with respect to the vertical, on-off valves 29 and 30 are closed to prevent any further pressurized-oil flow to or from variable-volume chambers 18a and 18b. Given the axial movement of main piston 16 towards cap 22, floating auxiliary piston 17 obviously remains resting against main piston 16, so that the total volume of variable-volume chamber 18c is still minimum.

Since variable-volume chambers 18a and 18b of hollow cylindrical body 14 are both filled completely with pressurized oil, i.e. non-compressible liquid, closure of on-off valves 29 and 30 locks baffle plate 8 in the desired work position, thus setting crusher 1 to the work configuration, i.e. ready to crush the material fed into crushing chamber 3.

With reference to FIG. 5, when a large, non-compressible body gets jammed inside the gap between baffle plate 8 and rotary drum 4 during normal operation of the crusher, movable rod 15 is subjected to severe axial thrust which causes it to withdraw inside hollow cylindrical body 14, thus moving main piston 16. Since variable-volume chamber 18a is filled completely with non-compressible liquid, the axial thrust transmitted by movable rod 15 to main piston 16 translates into a rapid increase in oil pressure inside variable-volume chamber 18a.

When the oil pressure inside variable-volume chamber 18a exceeds the gas pressure inside storage tank 26, i.e. the second given threshold value, partition membrane 28 in storage tank 26 deforms, so that the pressurized oil in variable-volume chamber 18a flows out into storage tank 26, thus reducing the total volume of variable-volume chamber 18a and so moving main piston 16 axially to withdraw movable rod 15.

If partial withdrawal of movable rod 15 inside hollow cylindrical body 14 produces a sudden fall in oil pressure inside variable-volume chamber 18a—indicating sufficient lift of baffle plate 8 to let the non-compressible body through between baffle plate 8 and rotary drum 4—the gas inside storage tank 26 pushes the pressurized oil back into variable-volume chamber 18a, which increases in volume until main piston 16 is again resting against floating auxiliary piston 17, thus restoring baffle plate 8 to the initial work position.

Conversely, if the oil pressure inside variable-volume chamber 18a continues to rise, despite partial withdrawal of movable rod 15—indicating insufficient lift of baffle plate 8 to let the non-compressible body through between baffle plate 8 and rotary drum 4—relief valve 25 is activated and, when the first threshold value is exceeded, releases in controlled manner from variable-volume chamber 18a enough pressurized oil for movable rod 15 to withdraw sufficiently to let the non-compressible body through.

In this case, to restore baffle plate 8 to the initial work position, on-off valve 29 is opened temporarily to feed more pressurized oil into variable-volume chamber 18a and so move main piston 16 back into position resting against floating auxiliary piston 17.

In connection with the above, it should be pointed out that, whereas main piston 16 slides axially inside hollow cylindrical body 14 to absorb the mechanical stress produced by a non-compressible body inside the gap between baffle plate 8 and rotary drum 4, floating auxiliary piston 17 remains stationary at all times inside hollow cylindrical body 14 to act as a reference of the initial work position of baffle plate 8.

Being permanently isolated from the hydraulic circuit of the crusher, variable-volume chamber 18b in fact cannot alter its volume, by being filled completely with a non-compressible liquid, so that floating auxiliary piston 17 acts as an adjustable stop for main piston 16. Any variation in the volume of variable-volume chamber 18a in fact is compensated by a corresponding variation in the volume of variable-volume chamber 18c, which, communicating directly with the outside or with the pressurized-fluid source via connecting conduit 19 may vary rapidly in total volume with no restriction whatsoever.

Using connecting members 9 for connection to the casing as described above has numerous advantages: using floating-piston, linear hydraulic actuators 13 provides for eliminating conventional anchoring stays and for fully automatic positioning of baffle plates 8. Baffle plates 8 of crusher 1 in fact are tilted by appropriately regulating pressurized-oil flow to linear hydraulic actuators 13 via the hydraulic circuit of the crusher, with no direct manual work required on the part of the operator to loosen and tighten bolts to move and/or lock baffle plates 8 into position, etc.

Clearly, changes may be made to crusher 1 as described and illustrated herein without, however, departing from the scope of the present invention.

1) A crusher (1) for rubble and similar, comprising an outer casing (2), a rotary drum (4) mounted for rotation inside a crushing chamber (3) formed in the outer casing (2), and at least one baffle plate (8) positioned inside the crushing chamber (3) to direct the raw material entering the crushing chamber (3) onto the peripheral surface of said rotary drum (4); said at least one baffle plate (8) being hinged to said outer casing (2) to oscillate, inside the crushing chamber (3), about a given rotation axis (B); and the crusher (1) also having connecting members (9) for connection to the casing which extend from the outer casing (2) to the baffle plate (8) to adjust the tilt angle (β) of said at least one baffle plate (8) as required with respect to the vertical; said connecting members (9) comprising at least one floating-piston, linear hydraulic actuator (13) interposed between the body of the baffle plate (8) and the outer casing (2) of the crusher; said crusher (1) being characterized in that said at least one floating-piston, linear hydraulic actuator (13) comprises a hollow cylindrical body (14), and a movable rod (15) inserted at least partly and in axially sliding manner inside the hollow cylindrical body (14); said linear hydraulic actuator (13) also comprising a main piston (16) and a floating auxiliary piston (17), both fitted in axially sliding manner inside the longitudinal cavity (14a) of the hollow cylindrical body (14), so as to define, inside said longitudinal cavity (14a), three complementary variable-volume chambers (18a, 18b, 18c); the main piston (16) being fixed rigidly to said movable rod (15), and the floating auxiliary piston (17) being fitted in axially sliding manner to an intermediate portion of the movable rod (15).

2) A crusher as claimed in claim 1, characterized in that the two variable-volume chambers (18a, 18b) at the two ends of the longitudinal cavity (14a) of said hollow cylindrical body (14) are filled with pressurized liquid, and the central variable-volume chamber (18c) communicates directly with a pressurized-gas or -fluid source; a first variable-volume chamber (18a) of said two variable-volume chambers (18a, 18b) at the two ends of said longitudinal cavity (14a) being bounded laterally by said main piston (16) and by the end of the longitudinal cavity (14a), and being reduced in volume when the movable rod (15) withdraws inside said hollow cylindrical body (14).

3) A crusher as claimed in claim 2, characterized in that said connecting members (9) for connection to the casing comprise a relief device (25) permitting selective outflow of pressurized liquid from said first variable-volume chamber (18a) when the pressure of the liquid in the first variable-volume chamber (18a) exceeds a first given threshold value.

4) A crusher as claimed in claim 3, characterized in that said connecting members (9) for connection to the casing comprise a storage tank (26) communicating with said first variable-volume chamber (18a) and which receives a variable quantity of pressurized liquid from the first variable-volume chamber (18a) when the pressure of said liquid exceeds a second given threshold value; said second threshold value being lower than said first threshold value of the relief device (25).

5) A crusher as claimed in claim 2, characterized in that said hollow cylindrical body (14) has two pressurized-liquid inlets (13a, 13b) by which pressurized liquid is fed to or drawn from said two variable-volume chambers (18a, 18b) at the two ends of the longitudinal cavity (14a) of said hollow cylindrical body (14); and in that said connecting members (9) for connection to the casing comprise means (29, 30) for selectively preventing pressurized-liquid flow to and from said inlets (13a, 13b).

6) A crusher as claimed in any one of the preceding claims 1, characterized in that said main piston (16) and said floating auxiliary piston (17) both have a cross section complementary to that of the longitudinal cavity (14a) of said hollow cylindrical body (14), so as to slide freely, parallel to a longitudinal axis (C), inside said longitudinal cavity (14a), and divide the space inside said longitudinal cavity (14a) into the said three complementary variable-volume chambers (18a, 18b, 18c).

7) A crusher as claimed in claim 3, characterized in that said hollow cylindrical body (14) has two pressurized-liquid inlets (13a, 13b) by which pressurized liquid is fed to or drawn from said two variable-volume chambers (18a, 18b) at the two ends of the longitudinal cavity (14a) of said hollow cylindrical body (14); and in that said connecting members (9) for connection to the casing comprise means (29, 30) for selectively preventing pressurized-liquid flow to and from said inlets (13a, 13b).

8) A crusher as claimed in claim 4, characterized in that said hollow cylindrical body (14) has two pressurized-liquid inlets (13a, 13b) by which pressurized liquid is fed to or drawn from said two variable-volume chambers (18a, 18b) at the two ends of the longitudinal cavity (14a) of said hollow cylindrical body (14); and in that said connecting members (9) for connection to the casing comprise means (29, 30) for selectively preventing pressurized-liquid flow to and from said inlets (13a, 13b).

9) A crusher as claimed in claim 2, characterized in that said main piston (16) and said floating auxiliary piston (17) both have a cross section complementary to that of the longitudinal cavity (14a) of said hollow cylindrical body (14), so as to slide freely, parallel to a longitudinal axis (C), inside said longitudinal cavity (14a), and divide the space inside said longitudinal cavity (14a) into the said three complementary variable-volume chambers (18a, 18b, 18c).

10) A crusher as claimed in claim 3, characterized in that said main piston (16) and said floating auxiliary piston (17) both have a cross section complementary to that of the longitudinal cavity (14a) of said hollow cylindrical body (14), so as to slide freely, parallel to a longitudinal axis (C), inside said longitudinal cavity (14a), and divide the space inside said longitudinal cavity (14a) into the said three complementary variable-volume chambers (18a, 18b, 18c).

11. A crusher as claimed in claim 4, characterized in that said main piston (16) and said floating auxiliary piston (17) both have a cross section complementary to that of the longitudinal cavity (14a) of said hollow cylindrical body (14), so as to slide freely, parallel to a longitudinal axis (C), inside said longitudinal cavity (14a), and divide the space inside said longitudinal cavity (14a) into the said three complementary variable-volume chambers (18a, 18b, 18c).

12. A crusher as claimed in claim 5, characterized in that said main piston (16) and said floating auxiliary piston (17) both have a cross section complementary to that of the longitudinal cavity (14a) of said hollow cylindrical body (14), so as to slide freely, parallel to a longitudinal axis (C), inside said longitudinal cavity (14a), and divide the space inside said longitudinal cavity (14a) into the said three complementary variable-volume chambers (18a, 18b, 18c).
